(19) United States
(12) Patent Application Publication
(10) Pub. No.: US 2024/0087608 A1
(43) Pub. Date: Mar. 14, 2024

(54) VIDEO SYNTHESIS METHOD AND APPARATUS, ELECTRONIC DEVICE AND STORAGE MEDIUM

(71) Applicant: Beijing Bytedance Network Technology Co., Ltd., Shijingshan District, Beijing (CN)

(72) Inventors: Feng ZHOU, Beijing (CN); Kaibo CHU, Beijing (CN); Junyue CAO, Beijing (CN)

(21) Appl. No.: 18/263,518

(22) PCT Filed: Jan. 17, 2022
(86) PCT No.: PCT/CN2022/072326

§ 371 Date: Jul. 28, 2023

(30) Foreign Application Priority Data
Jan. 29, 2021 (CN) 202110130072.8

(51) Int. Cl. G11B 27/02; H04N 21/854; H04N 21/858

(52) U.S. Cl. CPC G11B 27/02; H04N 21/854; H04N 21/8586

(57) ABSTRACT

Embodiments of the present disclosure provide a video synthesis method and apparatus, an electronic device and a storage medium. In the method, a web front end receives an operation of a user on a to-be-processed video, and records operation information as a draft; and sends the draft to a server, where the draft is used to perform processing on the to-be-processed video and perform video synthesis after the processing, which realizes the purpose of video synthesis through a web end.

### CROSS-REFERENCE TO RELATED APPLICATIONS

This application is a National Stage of International Application No. PCT/CN2022/072326, filed on Jan. 17, 2022, which claims priority to Chinese Patent Application No. 202110130072.8 filed to China National Intellectual Property Administration on Jan. 29, 2021 and entitled “VIDEO SYNTHESIS METHOD AND APPARATUS, ELECTRONIC DEVICE AND STORAGE MEDIUM”, both of which are hereby incorporated by reference in their entireties.

### TECHNICAL FIELD

Embodiments of the present disclosure relate to the technical field of video processing and, in particular, to a video synthesis method and apparatus, an electronic device and a storage medium.

### BACKGROUND

In order to improve a user's experience of watching a video, video editing software is usually used to perform multiple kinds of edit processing on the video, such as adding an audio, an image, a special effect, and synthesis processing is performed on the video before uploading the video, so that the effect of edit processing on the video can be reproduced when playing.

However, existing video synthesis can only be implemented through an application, and video synthesis cannot be implemented on a web (browser) end.

### SUMMARY

Embodiments of the present disclosure provide a video synthesis method and apparatus, an electronic device, a storage medium, a computer program product and a computer program, so as to overcome the problem that video synthesis cannot be implemented on a web end.

In a first aspect, an embodiment of the present disclosure provides a video synthesis method, applied to a world wide web (web) front end, where the method includes: receiving an operation of a user on a to-be-processed video and recording operation information as a draft; and sending the draft to a server, where the draft is used to perform processing on the to-be-processed video and perform video synthesis after the processing.

In a second aspect, an embodiment of the present disclosure provides a video synthesis method, applied to a server, where the method includes: receiving a draft sent by a world wide web (web) front end, where the draft records operation information of a user on a to-be-processed video; and performing processing on the to-be-processed video according to the draft, and performing video synthesis to obtain a video file.

In a third aspect, an embodiment of the present disclosure provides a video synthesis apparatus, applied to a world wide web (web) front end, where the apparatus includes: a processing module, configured to receive an operation of a user on a to-be-processed video and record operation information as a draft; and a sending module, configured to send the draft to a server, where the draft is used for the server to perform processing on the to-be-processed video and perform video synthesis after the processing.

In a fourth aspect, an embodiment of the present disclosure provides a video synthesis apparatus, applied to a server, where the apparatus includes: a receiving module, configured to receive a draft sent by a world wide web (web) front end, where the draft records operation information of a user on a to-be-processed video; and a synthesis module, configured to perform processing on the to-be-processed video according to the draft and perform video synthesis to obtain a video file.

In a fifth aspect, an embodiment of the present disclosure provides an electronic device including: at least one processor, and a memory; where the memory stores computer execution instructions; and the at least one processor executes the computer execution instructions stored in the memory, so that the at least one processor performs the video synthesis method according to the first aspect and various possible implementations of the first aspect.

In a sixth aspect, an embodiment of the present disclosure provides an electronic device including: at least one processor, and a memory; where the memory stores computer execution instructions; and the at least one processor executes the computer execution instructions stored in the memory, so that the at least one processor performs the video synthesis method according to the second aspect and various possible implementations of the second aspect.

In a seventh aspect, an embodiment of the present disclosure provides a computer-readable storage medium, where the computer-readable storage medium has computer execution instructions stored thereon, and when the computer execution instructions are executed by a processor, the video synthesis method according to the first aspect and various possible implementations of the first aspect is implemented.

In an eighth aspect, an embodiment of the present disclosure provides a computer-readable storage medium, where the computer-readable storage medium has computer execution instructions stored thereon, and when the computer execution instructions are executed by a processor, the video synthesis method according to the second aspect and various possible implementations of the second aspect is implemented.

In a ninth aspect, an embodiment of the present disclosure provides a computer program product. The computer program product includes a computer program, and the computer program is stored in a readable storage medium from which at least one processor of an electronic device can read the computer program. The at least one processor executes the computer program, so that the electronic device executes the video synthesis method according to the first aspect and various possible implementations of the first aspect, or the video synthesis method according to the second aspect and various possible implementations of the second aspect.

In a tenth aspect, an embodiment of the present disclosure provides a computer program. The computer program is stored in a readable storage medium, and at least one processor of an electronic device can read the computer program from the readable storage medium. The at least one processor executes the computer program, so that the electronic device executes the video synthesis method according to the first aspect and various possible implementations of the first aspect, or the video synthesis method according to the second aspect and various possible implementations of the second aspect.

The embodiments provide a video synthesis method and apparatus, an electronic device and a storage medium. In the method, a web front end receives an operation of a user on a to-be-processed video and records operation information as a draft; and sends the draft to a server, where the draft is used to perform processing on the to-be-processed video and perform video synthesis after the processing. In this way, the purpose of video synthesis through a web end is realized.

### BRIEF DESCRIPTION OF THE DRAWINGS

In order to illustrate the technical solutions of embodiments of the present disclosure or the prior art more clearly, the drawings required in the description of the embodiments or the prior art will be briefly introduced below. Obviously, the drawings in the following description are some embodiments of the present disclosure, and those skilled in the art can obtain other drawings according to these drawings without creative efforts.

FIG. 1 is a diagram of a system architecture according to an embodiment of the present disclosure.

FIG. 2 is schematic flow chart I of a video synthesis method according to an embodiment of the present disclosure.

FIG. 3 is schematic flow chart II of a video synthesis method according to an embodiment of the present disclosure.

FIG. 4 is a schematic diagram of a hierarchical structure of a web end according to an embodiment of the present disclosure.

FIG. 5 is a structural block diagram of a video synthesis apparatus applied to a web front end according to an embodiment of the present disclosure.

FIG. 6 is a structural block diagram of a video synthesis apparatus applied to a server according to an embodiment of the present disclosure.

FIG. 7 is a schematic structural diagram of an electronic device according to an embodiment of the present disclosure.

### DESCRIPTION OF EMBODIMENTS

In order to make the objectives, technical solutions, and advantages of embodiments of the present disclosure more clear, the technical solutions in the embodiments of the present disclosure will be described clearly and completely in the following with reference to the accompanying drawings of the embodiments of the present disclosure. It is obvious that the described embodiments are part of embodiments of the present disclosure, but not all embodiments. All other embodiments obtained by those skilled in the art based on the embodiments in the present disclosure without creative efforts are within the protection scope of the present disclosure.

In order to improve a user's experience of watching a video, video editing software is usually used to perform multiple kinds of edit processing on the video, such as adding an audio, an image, a special effect, and synthesis processing is performed on the video before uploading the video, so that the effect of edit processing on the video can be reproduced when playing. However, existing video synthesis can only be implemented through an application, and video synthesis cannot be implemented on a web (browser) end.

In view of the above problem, a technical conception of the present disclosure is to store operation information of a user on a video as a draft at a web front end, and send the draft to a background server corresponding to the web front end, so that the background server of the web end restores the video according to the draft and performs video synthesis.

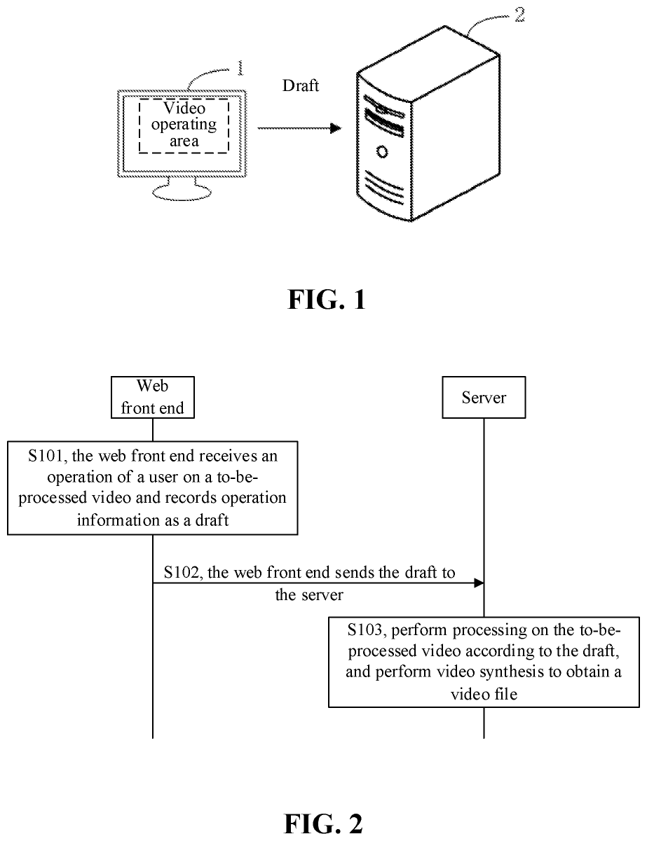

Reference is made to FIG. 1, which is a diagram of a system architecture according to an embodiment of this disclosure. As shown in FIG. 1, the schematic diagram of the system architecture according to an example of the present disclosure includes a web front end 1 and a server 2, and the server 2 may be a Linux system. The web front end 1 and the server 2 cooperate to implement the video synthesis method of the following embodiments.

Reference is made to FIG. 2, which is schematic flow chart I of a video synthesis method according to an embodiment of the present disclosure. As shown in FIG. 2, the video synthesis method includes the following steps.

S101, a web front end receives an operation of a user on a to-be-processed video and records operation information as a draft.

Specifically, the user can perform various operation processing such as adding and editing on the to-be-processed video at the web front end, for example, adding, deleting or modifying (cutting and moving the position) on an audio or a video, adding, deleting or modifying of a sticker, adding, deleting or modifying of a character, a special effect or the like, to obtain the operation information. In an implementation, the operation information includes video acquisition information and video editing information, etc. Specifically, the video acquisition information includes a link address of the to-be-processed video, and the video editing information includes parameters about adding, deleting, modifying, etc. Various video processing parameters in a processing process are recorded into a draft. In an implementation, the draft is in an object notation (JavaScript Object Notation, JSON for short) string format.

In one embodiment of the present disclosure, the method further includes displaying an operation effect of performing the operation on the to-be-processed video.

Specifically, a small video playing window may be included at the web end. When the user adds the to-be-processed video, the small video playing window can display the corresponding to-be-processed video. When the user performs various editing operations on the to-be-processed video, the small video playing window can display the corresponding processing effects, so that the user can know the edited video renderings in advance.

S102, the web front end sends the draft to a server.

The draft is used to perform processing on the to-be-processed video and perform video synthesis after the processing.

Specifically, after the draft is acquired, the web front end sends the draft to a background server corresponding to the web front end through a network.

Correspondingly, on a server side, the draft sent by the world wide web (web) front end will be received, and the draft records the operation information of the user on the to-be-processed video.

S103, the server performs processing on the to-be-processed video according to the draft, and performs video synthesis to obtain a video file.

Specifically, after the draft is acquired, the server will perform processing on the to-be-processed video according to the draft, and perform video synthesis on the to-be-processed video subject to the processing to obtain a video file.

In an implementation, the server will generate a link address of the video file and send the link address to the web front end. Correspondingly, the web front end receives the link address returned by the server which is an address of the video file obtained after the video synthesis, receives a download request of a user for the link address, and downloads the video file according to the download request.

Specifically, after the video file subject to the video synthesis is obtained, the server will generate the corresponding link address, and send the link address to the web front end. After the link address is received, the web front end will display it at the web front end. When a user clicks the link address for downloading, the user will get the corresponding synthesized video.

The embodiment of the present disclosure provides a video synthesis method, in which the web front end receives the operation of the user on the to-be-processed video and records the operation information as the draft; and sends the draft to the server, where the draft is used to perform processing on the to-be-processed video and perform video synthesis after the processing. In this way, the function of video synthesis through the web end is realized.

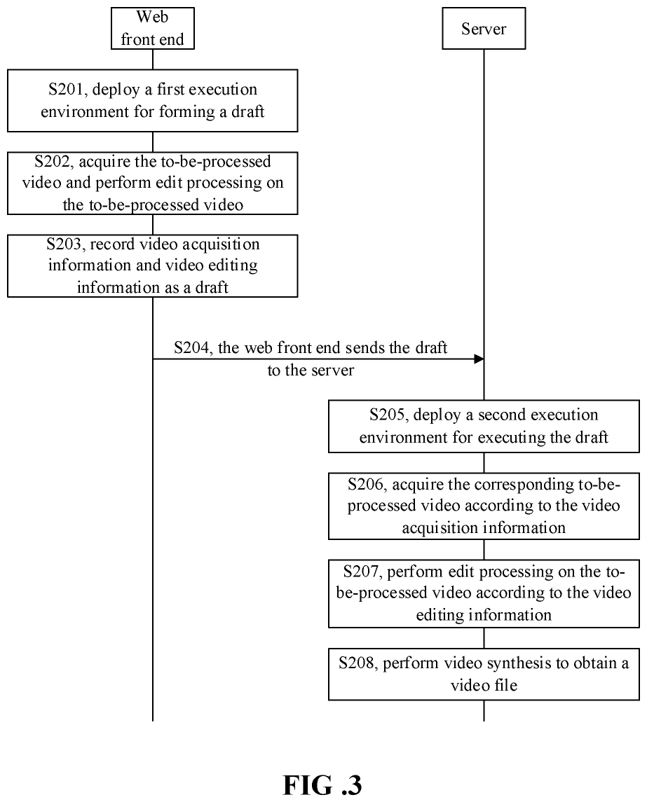

On the basis of the above embodiment shown in FIG. 2, FIG. 3 is schematic flow chart II of a video synthesis method according to an embodiment of the present disclosure. The operation information includes video acquisition information and video editing information. As shown in FIG. 3, the video synthesis method includes the following steps.

S201, the web front end deploys a first execution environment for forming the draft.

Specifically, the first execution environment includes a video processing component of the web front end and a draft framework of the web front end. The video processing component of the web front end is used to construct an operating environment for processing the to-be-processed video, and the draft framework of the web front end is used to construct an operating environment for forming the draft.

S202, the web front end acquires the to-be-processed video and performs edit processing on the to-be-processed video.

S203, the web front end records the video acquisition information and the video editing information as a draft.

S204, the web front end sends the draft to the server.

S205, the server deploys a second execution environment for executing the draft.

The second execution environment includes a video processing component of the server and a draft framework of the server. The video processing component of the server is used to construct an operating environment for performing restoration processing on the to-be-processed video, and the draft framework of the server is used to construct an operating environment applicable for the draft. It should be noted that code environments of the web front end and the server are different, so it is necessary to redeploy a code environment on the server.

S206, the server acquires the corresponding to-be-processed video according to the video acquisition information.

S207, the server performs edit processing on the to-be-processed video according to the video editing information.

S208, the server performs video synthesis to obtain the video file.

In this embodiment, step S204 is the same as step S102 in the above embodiment. Please refer to the discussion of step S102 for a detailed discussion, which will not be repeated here.

The difference from the above embodiment lies in that this embodiment further defines a specific implementation of step 101 and step 103. In this implementation, the web front end deploys the first execution environment for forming the draft. The web front end acquires the to-be-processed video, performs edit processing on the to-be-processed video, records video acquisition information and video editing information as the draft, and sends the draft to the server. The server deploys the second execution environment for executing the draft. The server acquires the corresponding to-be-processed video according to the video acquisition information, performs edit processing on the to-be-processed video according to the video editing information, and performs video synthesis to obtain the video file.

Specifically, firstly, it is necessary to initialize the operating environment of the web front end, including loading the video processing component of the web front end, so that the processing operations such as adding and editing can be performed on the to-be-processed video. At the same time, it is necessary to construct the draft framework, so that the parameters of the video acquisition information and the video editing information are filled in the draft framework to form the draft. Then the draft is sent to the server through the network. The operating environment of the server is initialized, the operating environment including the video processing component of the server and the draft framework of the server. Then the to-be-processed video is downloaded according to the video acquisition information in the received draft, and the to-be-processed video is edited according to the video editing information in the draft. Thereafter, video synthesis is performed to form the video file.

It should be noted that due to the different code environments of the web end and the server, when the draft formed at the web front end does not carry a code environment, such as a Json string, it is necessary to reconstruct on the server a code environment of the server in order to restore the draft.

In an implementation, the video acquisition information is a link address of the to-be-processed video in a Json string format, and the server downloads the corresponding to-be-processed video according to the link address.

For the convenience of understanding, the embodiment of the present disclosure will be further explained. Firstly, the web front end receives an operation instruction of the user, and initializes the video processing component and the draft framework of the web front end. Then the web front end receives a video adding instruction of the user, adds the corresponding to-be-processed video at the web front end, and records the address of the to-be-processed video into the draft framework. Then the web front end receives a video editing operation instruction of the user and performs operations (such as cutting, sorting, rotating, etc.) on the to-be-processed video, and at the same time records the video editing information into the draft framework to form a draft in the Json string format. Then the web front end sends the draft in the Json string format to the background server through the network. The background server initializes the video processing component and the draft framework of the server firstly, and then downloads the corresponding to-be-processed video according to the video acquisition information in the draft and restores the edit processing (such as cutting, sorting, rotating, etc.) of the to-be-processed video according to the video editing information. Then the background server performs video synthesis to form the video file and a corresponding link address, and returns the link address of the video file to the web front end. The web front end can accept a download request of a user for the link address and download the video.

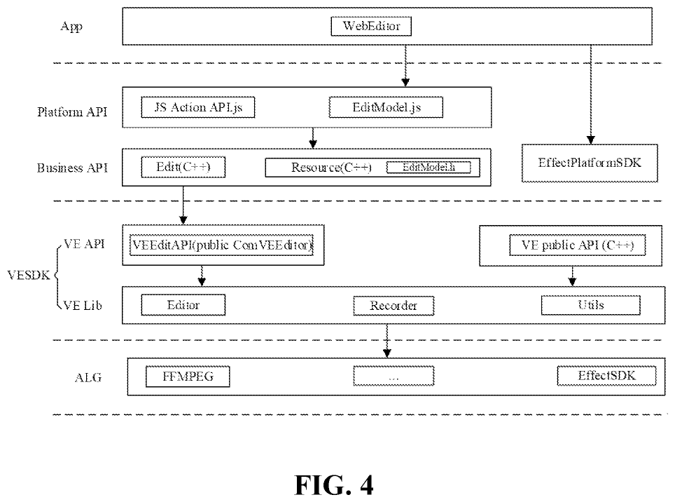

Reference is made to FIG. 4, which is a schematic diagram of a hierarchical structure of a web end according to an embodiment of the present disclosure. As shown in FIG. 4, the hierarchical structure of the web end sequentially includes, from bottom to top, an algorithm processing (algorithm, ALG for short) layer, a voice and video processing engine VESDK (video expression software development kit) layer, a business logic (Business) layer, a platform (Platform) layer, and an application (App) layer.

The ALG layer is algorithm processing at the bottom layer, for example, FFMPEG (fast forward moving picture expert group) is used to process each frame of a video, and EffectSDK is used to add a special effect to each frame of the video, etc. The VESDK layer includes VE API (video expression application programming interface) and VE Lib. VE Lib includes Editor, Recorder and Utils. Editor is used for video editing, such as cutting, sorting, rotating. Recorder is used for recording, shooting, etc. Utils is used for handling common tools. VE API includes VE public API, which is used to process data of VE lib abstractly and provide external interface calling. Business API includes Edit(C++) and Resource(C++), which are used to initialize the operating environment of the web front end and provide external interface calling. Platform API (the platform layer) is applied to the web end as an example of the present disclosure, and adopts js processing. The APP layer is an application layer for interaction with users.

It should be noted that, compared with the problem in the prior art that the web end cannot export a draft, the Business API layer in the hierarchical structure of the web end given in the embodiment of the present disclosure includes Resource(C++), which can implement operations related to a draft and provide the function of draft export. Similarly, a hierarchical structure of the server is similar to that in FIG. 4, which will not be repeated here.

Now, the embodiment of the present disclosure will be further explained in combination with the hierarchical structure of the web end shown in FIG. 4.

Firstly, Edit(C++) in the Business API layer is initialized, and Edit(C++) controls the initialization of Editor in the VE Lib layer, so as to realize the initialization of the video processing component at the web end. At the same time, Resource(C++) in the Business API layer is initialized to construct the draft framework. After the initialization is completed, the user adds the to-be-processed video through the App layer. Control is performed toward the lower layer to record the added video in the draft of Resource(C++) in the Business API layer, and Editor in the VE Lib layer may also be controlled to update for previewing and displaying the to-be-processed video. When performing edit processing (such as cutting) on the to-be-processed video, the user initiates an edit processing instruction (such as cutting) through the App layer. Edit(C++) in the Business API layer controls Editor in the VE Lib layer to perform edit processing (such as cutting) on the video. Then the draft of the j son string is exported from Resource(C++) in the Business API layer and sent to the server. Because the j son string does not carry an operating environment, the server will initialize Edit(C++) in the Business API layer firstly, and Edit(C++) controls the initialization of Editor in the VE Lib layer to realize the loading of the video processing component of the server. At the same time, Resource(C++) in the Business API layer is initialized to construct the draft framework of the server. Then Resource(C++) in the Business API layer receives the Json string delivered by the upper layer and parses it, and controls Edit(C++) in the Business API layer. Edit(C++) controls Editor in the VE Lib layer to download the video and perform restoration processing. After the restoration processing is completed, Resource(C++) in the Business API layer sends out a video synthesis instruction to inform Editor in the VE Lib layer to perform video synthesis to form a video file, and returns a link address of the video file to the web front end.

The embodiment of the present disclosure provides a video synthesis method. In the method, the web front end deploys the first execution environment for forming the draft; acquires the to-be-processed video and performs edit processing on the to-be-processed video; records the video acquisition information and the video editing information as the draft, and sends the draft to the server. The server deploys the second execution environment for executing the draft; acquires the corresponding to-be-processed video according to the video acquisition information; performs edit processing on the to-be-processed video according to the video editing information, and performs video synthesis to obtain the video file. In this way, the function of video synthesis at the web end is realized.

An embodiment of the present disclosure provides a video synthesis method, which is applied to a world wide web (web) front end. The method includes: receiving an operation of a user on a to-be-processed video and recording operation information as a draft; and sending the draft to a server, where the draft is used to perform processing on the to-be-processed video and perform video synthesis after the processing.

According to one or more embodiments of the present disclosure, receiving the operation of the user on the to-be-processed video and recording the operation information as the draft includes: acquiring the to-be-processed video, and performing edit processing on the to-be-processed video; and recording video acquisition information and video editing information as the draft.

According to one or more embodiments of the present disclosure, before recording the operation information as the draft, the method further includes: deploying a first execution environment for forming the draft.

According to one or more embodiments of the present disclosure, the method further includes: receiving a link address returned by the server, where the link address is an address of a video file obtained after the video synthesis is performed; and receiving a download request of a user for the link address, and downloading the video file according to the download request.

According to one or more embodiments of the present disclosure, the method further includes: displaying an operation effect of performing the operation on the to-be-processed video.

According to one or more embodiments of the present disclosure, the draft is in an object notation JSON string format.

The video synthesis method according to this embodiment has implementation principles and technical effects similar to those of the above embodiment, details of which will not be repeated here in this embodiment.

An embodiment of the present disclosure further provides a video synthesis method, which is applied to a server. The method includes: receiving a draft sent by a world wide web (web) front end, where the draft records operation information of a user on a to-be-processed video; and performing processing on the to-be-processed video according to the draft, and performing video synthesis to obtain a video file.

According to one or more embodiments of the present disclosure, the operation information includes video acquisition information and video editing information, and performing processing on the to-be-processed video according to the draft includes: acquiring a corresponding to-be-processed video according to the video acquisition information; and performing edit processing on the to-be-processed video according to the video editing information.

According to one or more embodiments of the present disclosure, before performing processing on the to-be-processed video according to the draft, the method further includes: deploying a second execution environment for executing the draft.

According to one or more embodiments of the present disclosure, the method further includes: generating a link address of the video file, and sending the link address to the web front end.

The video synthesis method according to this embodiment has implementation principles and technical effects similar to those of the above embodiment, details of which will not be repeated here in this embodiment.

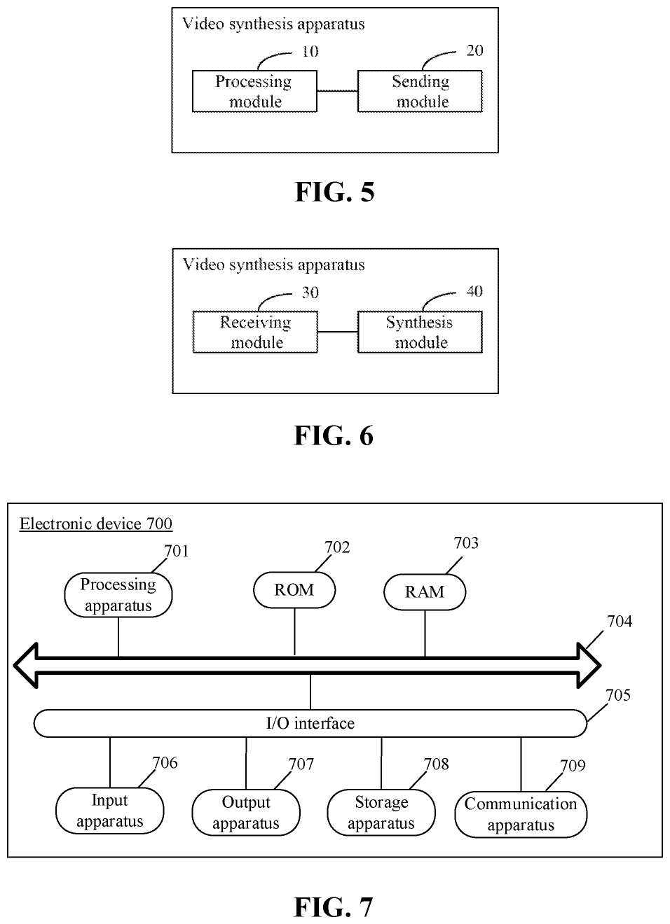

Corresponding to the video synthesis method of the above embodiments, FIG. 5 is a structural block diagram of a video synthesis apparatus applied to a web front end according to an embodiment of the present disclosure. For convenience of explanation, only parts related to the embodiment of the present disclosure are shown. Referring to FIG. 5, the video synthesis apparatus includes a processing module 10 and a sending module 20.

The processing module 10 is configured to receive an operation of a user on a to-be-processed video and record operation information as a draft. The sending module 20 is configured to send the draft to a server, where the draft is used for the server to perform processing on the to-be-processed video and perform video synthesis after the processing.

In one embodiment of the present disclosure, the processing module 10 is specifically configured to: acquire the to-be-processed video, and perform edit processing on the to-be-processed video; and record video acquisition information and video editing information as the draft.

In one embodiment of the present disclosure, the processing module 10 is further configured to deploy a first execution environment for forming the draft.

In one embodiment of the present disclosure, the processing module 10 is further configured to: receive a link address returned by the server, where the link address is an address of a video file obtained after the video synthesis is performed; and receive a download request of a user for the link address, and download the video file according to the download request.

In one embodiment of the present disclosure, the processing module 10 is further configured to display an operation effect of performing the operation on the to-be-processed video.

The video synthesis apparatus according to this embodiment can be used to implement the technical solutions of the above method embodiments. The implementation principles and technical effects thereof are similar, and details will not be repeated here in this embodiment.

FIG. 6 is a structural block diagram of a video synthesis apparatus applied to a server according to an embodiment of the present disclosure. For convenience of explanation, only parts related to the embodiment of the present disclosure are shown. Referring to FIG. 6, the video synthesis apparatus includes a receiving module 30 and a synthesis module 40.

The receiving module 30 is configured to receive a draft sent by a world wide web (web) front end, where the draft records operation information of a user on a to-be-processed video. The synthesis module 40 is configured to perform processing on the to-be-processed video according to the draft and perform video synthesis to obtain a video file.

In one embodiment of the present disclosure, the operation information includes video acquisition information and video editing information, and the synthesis module 40 is specifically configured to: acquire a corresponding to-be-processed video according to the video acquisition information; and perform edit processing on the to-be-processed video according to the video editing information.

In one embodiment of the present disclosure, the synthesis module 40 is further configured to deploy a second execution environment for executing the draft.

In one embodiment of the present disclosure, the synthesis module 40 is further configured to generate a link address of the video file and send the link address to the web front end.

The video synthesis apparatus according to this embodiment can be used to implement the technical solutions of the above method embodiments. The implementation principles and technical effects thereof are similar, and details will not be repeated here in this embodiment.

Reference is made to FIG. 7, which is a schematic structural diagram of an electronic device according to an embodiment of the present disclosure. As shown in FIG. 7, the electronic device 700 may be disposed at a web front end, and include: at least one processor and a memory. The memory stores computer execution instructions, and the at least one processor executes the computer execution instructions stored in the memory, so that the at least one processor performs the video synthesis method as described in the first aspect and various possible designs of the first aspect.

Similar to the structure in FIG. 7, an example of the present disclosure further proposes an electronic device, which is disposed on a server side and includes: at least one processor and a memory. The memory stores computer execution instructions, and the at least one processor executes the computer execution instructions stored in the memory, so that the at least one processor performs the video synthesis method as described in the second aspect and various possible designs of the second aspect.

The electronic device 700 may be a terminal device or a server. The terminal device may include, but is not limited to, a mobile terminal such as a mobile phone, a notebook, a digital broadcast receiver, a Personal Digital Assistant (PDA for short), a Portable Android Device (PAD for short), a Portable Media Player (PMP for short), a vehicle-mounted terminal (such as a vehicle-mounted navigation terminal); and a fixed terminal such as a digital TV, a desktop computer. The electronic device shown in FIG. 7 is only an example, and should not bring any limitation to the functions and application scope of the embodiments of the present disclosure.

As shown in FIG. 7, the electronic device 700 may include a processing apparatus (such as a central processing unit, a graphics processor, etc.) 701, which may perform various appropriate actions and processing according to a program stored in a Read Only Memory (ROM for short) 702 or a program loaded from a storage apparatus 708 into a Random Access Memory (RAM for short) 703. In the RAM 703, various programs and data required for operations of the electronic device 700 are further stored. The processing apparatus 701, the ROM 702 and the RAM 703 are connected to each other through a bus 704. An input/output (I/O for short) interface 705 is also connected to the bus 704.

Generally, the following apparatuses may be connected to the I/O interface 705: an input apparatus 706 (including, for example, a touch screen, a touch pad, a keyboard, a mouse, a camera, a microphone, an accelerometer, a gyroscope, etc.), an output apparatus 707 (including, for example, a Liquid Crystal Display (LCD for short), a speaker, a vibrator, etc.), a storage apparatus 708 (including, for example, a magnetic tape, a hard disk, etc.), and a communication apparatus 709. The communication apparatus 709 may allow the electronic device 700 to perform wireless or wired communication with other devices to exchange data. Although FIG. 7 shows the electronic device 700 with various apparatuses, it should be understood that it is not required to implement or have all the apparatuses shown. More or fewer apparatuses may alternatively be implemented or possessed.

In particular, according to an embodiment of the present disclosure, a process described above with reference to a flowchart may be implemented as a computer software program. For example, an embodiment of the present disclosure includes a computer program product, which includes a computer program carried on a computer-readable medium and is disposed at a web front end and a server side. The computer program contains program codes for performing the method as shown in the flowchart. In such embodiment, the computer program may be downloaded and installed from a network through the communication apparatus 709, or installed from the storage apparatus 708, or installed from the ROM 702. When the computer program is executed by the processing apparatus 701, the above functions defined in the method of the embodiment of the present disclosure are performed.

It should be noted that the above-mentioned computer-readable medium in the present disclosure may be a computer-readable signal medium or a computer-readable storage medium or any combination thereof, and may be disposed at a web end and a server side. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to, an electrical connection with one or more wires, a portable computer disk, a hard disk, a random access memory (RAM), a read only memory (ROM), an Erasable Programmable Read-Only Memory (EPROM or flash for short), an optical fiber, a Portable Compact Disk Read-Only Memory (CD-ROM for short), an optical storage device, a magnetic storage device, or any suitable combination thereof. In the present disclosure, a computer-readable storage medium may be any tangible medium containing or storing a program, and the program may be used by or in combination with an instruction execution system, apparatus or device. In the present disclosure, a computer-readable signal medium may include a data signal propagated in a baseband or as part of a carrier wave and carry computer-readable program codes therein. This kind of propagated data signal may take many forms, including but not limited to an electromagnetic signal, an optical signal or any suitable combination thereof. A computer-readable signal medium may also be any computer-readable medium other than a computer-readable storage medium, and may send, propagate or transmit a program for use by or in combination with an instruction execution system, apparatus or device. The program codes contained in a computer-readable medium may be transmitted by any suitable medium, including but not limited to: a wire, an optical cable, a Radio Frequency (RF for short), etc., or any suitable combination thereof.

The computer-readable medium may be included in the electronic device described above, or may exist alone without being assembled into the electronic device.

The computer-readable medium carries one or more programs, and the one or more programs, when executed by the electronic device, cause the electronic device to perform the method shown in the above embodiments.

Computer program codes for performing the operations of the present disclosure may be written in one or more programming languages or combinations thereof, the programming languages including object-oriented programming languages such as Java, Smalltalk, C++, and further including conventional procedural programming languages such as “C” language or similar programming languages. The program codes may be completely executed on a user computer, partially executed on a user computer, executed as an independent software package, partially executed on a user computer and partially executed on a remote computer, or completely executed on a remote computer or server. In the case involving a remote computer, the remote computer may be connected to the user computer through any kind of network, including a Local Area Network (LAN for short) or a Wide Area Network (WAN for short), or may be connected to an external computer (for example, through the Internet by using an Internet service provider).

An embodiment of the present disclosure further provides a computer program, which is stored in a readable storage medium. At least one processor of an electronic device can read the computer program from the readable storage medium, and at least one processor executes the computer program, so that the electronic device performs the method according to any of the above embodiments.

The flowcharts and block diagrams in the drawings illustrate the architecture, functions and operations of possible implementations of systems, methods and computer program products according to various embodiments of the present disclosure. In this regard, each block in the flowcharts or block diagrams may represent a module, a program segment, or a part of code that contains one or more executable instructions for implementing a specified logical function. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, may be implemented by a dedicated hardware-based system that performs specified functions or operations, or may be implemented by a combination of dedicated hardware and computer instructions.

The modules involved in the embodiments described in the present disclosure may be implemented through software or hardware. The name of a module does not constitute the limitation of the module itself in some cases. For example, a sending module may also be described as “a module that sends a draft to a server”.

The functions described above herein may be at least partially performed by one or more hardware logic components. For example, exemplary types of hardware logic components that may be used include, without limitation, a Field-Programmable Gate Array (FPGA for short), an Application Specific Integrated Circuit (ASIC for short), an Application Specific Standard Product (ASSP for short), a System-on-a-chip (SOC for short), a Complex Programmable Logic Device (CPLD for short), etc.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine readable medium may include, but is not limited to, an electronic, magnetic, optical, electromagnetic, infrared, or semiconductor system, apparatus or device, or any suitable combination thereof. More specific examples of the machine-readable storage medium may include an electrical connection based on one or more lines, a portable computer disk, a hard disk, a random access memory (RAM), a read only memory (ROM), an erasable programmable read-only memory (EPROM or flash memory), an optical fiber, a portable compact disk read-only memory (CD-ROM), an optical storage device, a magnetic storage device, or any suitable combination thereof.

The above description is merely an illustration of the preferred embodiments of the present disclosure and the applied technical principles. It should be understood by those skilled in the art that the scope of disclosure involved in the present disclosure is not limited to the technical solutions formed by the specific combinations of the above technical features, and should also cover other technical solutions formed by any combinations of the above technical features or equivalent features thereof without departing from the disclosed concept, for example, technical solutions formed by interchanging the above-mentioned features with, but not limited to, technical features having similar functions disclosed in the present disclosure.

In addition, while operations are depicted in a particular order, this should not be understood as requiring that such operations be performed in the particular order shown or in a sequential order. In certain circumstances, multitasking and parallel processing may be advantageous. Likewise, while several specific implementation details are contained in the above discussion, these should not be construed as limitations on the scope of the disclosure. Certain features that are described in the context of separate embodiments may also be combined to be implemented in a single embodiment. Conversely, various features that are described in the context of a single embodiment may also be implemented in multiple embodiments separately or in any suitable sub-combinations.

Although the subject matter has been described in language specific to structural features and/or methodological actions, it should be understood that the subject matter defined in the appended claims is not necessarily limited to the specific features or actions described above. Rather, the specific features and actions described above are merely exemplary forms of implementing the claims.

What is claimed is:

1. A video synthesis method, applied to a world wide web web front end, wherein the method comprises:
receiving an operation of a user on a to-be-processed video and recording operation information as a draft; and
sending the draft to a server, wherein the draft is used to perform processing on the to-be-processed video and perform video synthesis after the processing.

2. The method according to claim 1, wherein receiving the operation of the user on the to-be-processed video and recording the operation information as the draft comprises:
acquiring the to-be-processed video, and performing edit processing on the to-be-processed video; and
recording video acquisition information and video editing information as the draft.

3. The method according to claim 1, wherein before recording the operation information as the draft, the method further comprises:
deploying a first execution environment for forming the draft.

4-17. (canceled)

18. The method according to claim 2, wherein before recording the operation information as the draft, the method further comprises:
deploying a first execution environment for forming the draft.

19. The method according to claim 1, wherein the method further comprises:
receiving a link address returned by the server, wherein the link address is an address of a video file obtained after the video synthesis is performed; and
receiving a download request of a user for the link address, and downloading the video file according to the download request.

20. The method according to claim 1, wherein the method further comprises:
displaying an operation effect of performing the operation on the to-be-processed video.

21. An electronic device, comprising: at least one processor, and a memory; wherein
the memory stores computer execution instructions; and
the at least one processor executes the computer execution instructions stored in the memory, so that the at least one processor performs the following steps:
receiving an operation of a user on a to-be-processed video and recording operation information as a draft; and
sending the draft to a server, wherein the draft is used to perform processing on the to-be-processed video and perform video synthesis after the processing.

22. The electronic device according to claim 21, wherein the at least one processor executes the computer execution instructions stored in the memory, so that the at least one processor performs the following steps:
acquiring the to-be-processed video, and performing edit processing on the to-be-processed video; and
recording video acquisition information and video editing information as the draft.

23. The electronic device according to claim 21, wherein the at least one processor executes the computer execution instructions stored in the memory, so that the at least one processor performs the following step:
deploying a first execution environment for forming the draft.

24. The electronic device according to claim 22, wherein the at least one processor executes the computer execution instructions stored in the memory, so that the at least one processor performs the following step:
deploying a first execution environment for forming the draft.

25. The electronic device according to claim 21, wherein the at least one processor executes the computer execution instructions stored in the memory, so that the at least one processor performs the following steps:
receiving a link address returned by the server, wherein the link address is an address of a video file obtained after the video synthesis is performed; and
receiving a download request of a user for the link address, and downloading the video file according to the download request.

26. The electronic device according to claim 21, wherein the at least one processor executes the computer execution instructions stored in the memory, so that the at least one processor performs the following step:
displaying an operation effect of performing the operation on the to-be-processed video.

27. An electronic device, comprising: at least one processor, and a memory; wherein
the memory stores computer execution instructions; and
the at least one processor executes the computer execution instructions stored in the memory, so that the at least one processor performs the following steps:
receiving a draft sent by a world wide web (web) front end, wherein the draft records operation information of a user on a to-be-processed video; and
performing processing on the to-be-processed video according to the draft, and performing video synthesis to obtain a video file.

28. The electronic device according to claim 27, wherein the operation information comprises video acquisition information and video editing information, and the at least one processor executes the computer execution instructions stored in the memory, so that the at least one processor performs the following steps:
acquiring a corresponding to-be-processed video according to the video acquisition information; and
performing edit processing on the to-be-processed video according to the video editing information.

29. The electronic device according to claim 27, wherein the at least one processor executes the computer execution instructions stored in the memory, so that the at least one processor performs the following step:
deploying a second execution environment for executing the draft.

30. The electronic device according to claim 28, wherein the at least one processor executes the computer execution instructions stored in the memory, so that the at least one processor performs the following step:
deploying a second execution environment for executing the draft.

31. The electronic device according to claim 27, wherein the at least one processor executes the computer execution instructions stored in the memory, so that the at least one processor performs the following steps:
generating a link address of the video file, and sending the link address to the web front end.

32. The electronic device according to claim 28, wherein the at least one processor executes the computer execution instructions stored in the memory, so that the at least one processor performs the following steps:
generating a link address of the video file, and sending the link address to the web front end.

33. The electronic device according to claim 29, wherein the at least one processor executes the computer execution instructions stored in the memory, so that the at least one processor performs the following steps:
generating a link address of the video file, and sending the link address to the web front end.

34. A non-transitory computer-readable storage medium, wherein the non-transitory computer-readable storage medium has computer execution instructions stored thereon, and when the computer execution instructions are executed by a processor, the video synthesis method according to claim 1 is implemented.
